(19) United States
(12) Patent Application Publication
(10) Pub. No.: US 2025/0124276 A1
(43) Pub. Date: Apr. 17, 2025

(54) METHODS FOR TRAINING AND DEPLOYING AN ARTIFICIAL INTELLIGENCE MODEL FOR USE WITH PREDICTING A TASK OUTPUT

(71) Applicant: Toyota Research Institute, Inc., Los Altos, CA (US)

(72) Inventors: Francine R. Chen, Menlo Park, CA (US); Yanxia Zhang, Foster City, CA (US); Minh Nguyen, New York, NY (US)

(73) Assignees: Toyota Research Institute, Inc., Los Altos, CA (US); Toyota Jidosha Kabushiki Kaisha, Aichi-ken (JP)

(21) Appl. No.: 18/486,247

(22) Filed: Oct. 13, 2023

(51) Int. Cl. G06N 3/08; G06N 3/0455

(52) U.S. Cl. CPC G06N 3/08; G06N 3/0455

(57) ABSTRACT

The present disclosure is directed to methods for training and using an artificial intelligence model for use with predicting a task output. The method includes generating a plurality of individual datasets, each of the plurality of individual datasets comprising data of at least one answer to at least one of a plurality of questions of each of a plurality of questionnaires, generating a first batch of individual datasets, the first batch of individual datasets comprising one or more of the plurality of individual datasets, inputting the first batch of individual datasets into the artificial intelligence model, and encoding the data of the first batch of individual datasets with an autoencoder.

### FIELD

The present disclosure relates to methods for training and deploying an artificial intelligence model to predict task outputs.

### TECHNICAL BACKGROUND

Tasks, such as answers to questions of a questionnaire, may be predicted by artificial intelligence models. Artificial intelligence models may be trained to predict consumer's likely answers to questions based upon consumer's answers to other questions. Personality traits of consumers, such as risk tolerance, product preferences, or various other traits, may be useful for corporations and producers to know in order to better tailor products to fit consumers' preferences. Conventional personality questionnaires may require consumers to answer large numbers of questions to gather a full profile of a consumer's personality and preferences. However, consumers may not desire to provide answers to large numbers of personality questions and questionnaires because of the time associated with answering such questions, or data may be skewed as consumers lose focus and rush through answering a large number of questions.

### SUMMARY

Consumers may complete questionnaires and surveys so that corporations and producers may gauge consumer preferences. However, consumers may not desire to answer large numbers of questions. Conventional systems may estimate consumers' answers to questionnaires and surveys using cognitive theories about the utility of different choice options. These systems may not estimate consumers' answers to questionnaires with sufficient accuracy for the estimations to be useable. Therefore, there exists a need for methods for training and deploying an artificial intelligence model to predict answers to questions based upon a user's prior answers to other questions. The present method can train and deploy an artificial intelligence to more accurately estimate a user's likely answers to questions based on the user's answers to other questions.

The system generally includes an AI device, a training device, a server, a network, a testing device, and a question taking device. The training device may store a training dataset which may be used to train an AI model stored on the AI device. The testing device may store a testing dataset which may be used to test the AI model. The question taking device may allow a user to answer one or more questions of one or more questionnaires. The AI model may predict the user's likely answers to other questions of the questionnaires based upon the user's answers to one or more questions of the one or more questionnaires.

According to one embodiment, a method includes generating a plurality of individual datasets, each of the plurality of individual datasets comprising data of at least one answer to at least one of a plurality of questions of each of a plurality of questionnaires, generating a first batch of individual datasets, the first batch of individual datasets comprising one or more of the plurality of individual datasets, inputting the first batch of individual datasets into the artificial intelligence model, and encoding the data of the first batch of individual datasets with an autoencoder.

According to another embodiment, a method includes the trained artificial intelligence model receiving at least one answer to at least one question from a baseline questionnaire, the trained artificial intelligence model comprising a self-attention layer, the self-attention layer creating a latent vector of the at least one answer to the at least one question from the baseline questionnaire, feeding the latent vector through a decoder of the trained artificial intelligence model, and the trained artificial intelligence model predicting an answer to at least one question from at least one of a plurality of questionnaires, each of the plurality of questionnaires being different than the baseline questionnaire.

Additional features and advantages of the technology described in this disclosure will be set forth in the detailed description which follows, and in part will be readily apparent to those skilled in the art from the description or recognized by practicing the technology as described in this disclosure, including the detailed description which follows, the claims, as well as the appended drawings.

### BRIEF DESCRIPTION OF THE DRAWINGS

The following detailed description of the present disclosure may be better understood when read in conjunction with the following drawings in which:

FIG. 1 schematically depicts a view of a network of devices for performing a method, according to one or more embodiments shown and described herein;

FIG. 2 schematically depicts a view of a network of devices for performing a method, according to one or more embodiments shown and described herein;

FIG. 3 schematically depicts a view of a network of devices for performing a method, according to one or more embodiments shown and described herein;

FIG. 4 schematically depicts a flowchart of a method according to one or more embodiments shown and described herein;

FIG. 5 schematically depicts a flowchart of a method according to one or more embodiments shown and described herein;

FIG. 6 schematically depicts a flowchart of a method according to one or more embodiments shown and described herein; and

FIG. 7 schematically depicts an example of the AI model architecture according to one or more embodiments shown and described herein.

Reference will now be made in greater detail to various embodiments of the present disclosure, some embodiments of which are illustrated in the accompanying drawings. Whenever possible, the same reference numerals will be used throughout the drawings to refer to the same or similar parts.

### DETAILED DESCRIPTION

Embodiments of the present disclosure are directed to methods for training and deploying an artificial intelligence model to predict a task output. The method for training the artificial intelligence model may include generating a plurality of individual datasets based on a user's answers to questions from questionnaires. The method may include generating a first batch of individual datasets, where the first batch of individual datasets is made up of the plurality of individual datasets. The first batch of individual datasets may be input into the artificial intelligence model to train the artificial intelligence model. The method for deploying an artificial intelligence model to predict a task output may include the trained artificial intelligence model receiving an answer to a question. The trained artificial intelligence model may predict a user's likely answers to further questions based upon the user's answer to the first question.

Conventional personality assessments may require a user to answer a large number of questions, which users may not desire to do and/or may result in inaccurate information due to fatigue or loss of attention. The present system can result in more efficiently and accurately assessing a user's personality and preferences based upon the user's answers to a smaller number of personality questions and questionnaires.

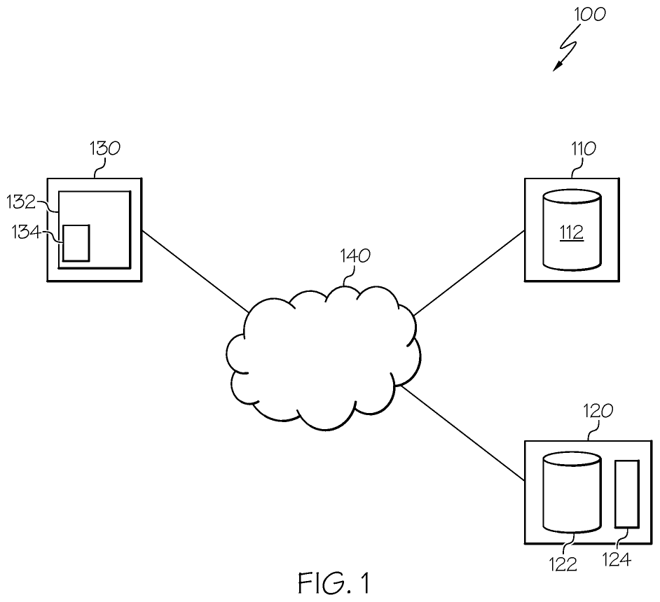

Referring now to FIG. 1, an example of a system 100 for training an artificial intelligence (AI) model 112 is shown consistent with a disclosed embodiment. As shown in FIG. 1, an AI device 110, a training device 120, and a server 130 are communicatively coupled to one another via a network 140. Although a specific numbers of AI devices, training devices, and servers are depicted in FIG. 1, any number of these devices may be provided. Furthermore, the functions provided by one or more devices of system 100 may be combined and the functionality of any one or more components of system 100 may be implemented by any appropriate computing environment.

Network 140 facilitates communications between the various devices in system 100, such as AI device 110, training device 120, and server 130. Network 140 may be a shared, public, or private network, may encompass a wide area or local area, and may be implemented through any suitable combination of wired and/or wireless communication networks. Furthermore, network 140 may include a local area network (LAN), a wide area network (WAN), an intranet, or the Internet. The network 140 may allow for near-real time communication between devices connected over the network.

Server 130 may include a processor 132. The processor 132 may include a non-transitory, processor-readable storage medium 134 for storing program modules that, when executed by the processor 132, perform one or more processes described herein. Non-transitory, processor-readable storage medium 134 may store data from other devices, such as the training device 120 and the AI device 110. Non-transitory, processor-readable storage medium 134 may be one or more memory devices that store data as well as software and may also comprise, for example, one or more of RAM, ROM, magnetic storage, or optical storage. Since disclosed embodiments may be implemented using an HTTPS (hypertext transfer protocol secure) environment, data transfer over a network, such as the Internet, may be done in a secure fashion.

AI device 110 may house an AI model 112. The AI model 112 may contain a plurality of layers. Each layer may include a plurality of nodes. One or more nodes of each layer may be connected to one or more nodes of the previous layer and/or the subsequent layer. The nodes may also be referred to as neurons. Each node may process input data using a weight value and a bias value. Each node may multiply the input data by the weight value and add the bias value to the input value multiplied by the weight value. The weight and bias value of each node may be randomly assigned before training the AI model 112, or the operator may specify the weight and bias value of each node before training the AI model 112. The weight and bias value of each node may be adjusted during the training of the AI model 112, as will be described herein. The weight and bias value of each node may be adjusted so as to increase the performance of the AI model 112.

The performance of the AI model 112 may be measured using one or more loss functions, and the AI model 112 may use a loss function to determine how to adjust the weight and/or bias of each node. The weight value may be plotted on a gradient of weight value versus loss value. The mathematical derivative of the initial weight and loss value may be taken to determine slope of the gradient. The slope may indicate to the AI model 112 which direction to adjust the weight of the node to reduce the loss value. Where multiple nodes are used each with their own weight value, the mathematical derivative may be a vector of partial derivatives with respect to the weight value of each node. The value of the partial derivative of the node of the final hidden layer may be multiplied by any nodes from the previous hidden layer which are connected to the node of the final hidden layer to adjust the weight of the nodes of the previous hidden layer. This process may be repeated through each node of each hidden layer. This process may also be called backpropagation. The same process may be used to adjust the bias value of each node, where the gradient shows the loss versus the bias value.

The loss functions may be used to adjust the weight and bias of each node to improve the performance of the AI model 112. That is, the value of each loss function may provide an indication to the AI model 112 of the performance of the AI model 112 relative to the specified threshold performance, which the AI model 112 may use to adjust the weight and bias of each node to increase the performance of the AI model towards the specified threshold. In some embodiments, the loss function may be based on the sum of a choice prediction loss and a reconstruction loss. The choice prediction loss may be the mean squared error between the true target and the predicted output of the AI model 112. The reconstruction loss may be the mean squared error between the true target and the predicted output of the AI model 112.

The AI model 112 may include one or more transformer blocks. The one or more transformer blocks may be a self-attention network, a cross-attention network, or any other suitable type of transformer blocks. The transformer blocks may encode personal information, such as answers to questions of the questionnaire. The transformer blocks may produce hidden representations of the questionnaire. The self-attention network of the AI model 112 includes an autoencoder. The autoencoder may allow the AI model 112 to learn relationships between answers to questions in the one or more questionnaires. As a non-limiting example, the AI model 112 may learn that users who answer one question in a particular way are more likely to answer other questions in a particular way. The AI model 112 may also learn that users that answer combinations of questions in a particular way are more likely to answer other questions in a particular way. This may allow the AI model 112 to predict user's likely answers to questions based on answers to other questions. This may be used to allow a user to answer fewer questions while the AI model 112 predicts their likely output to other questions. This may save time and effort for the user, while allowing entities utilizing the AI model 112 to predict a more complete assessment of a user's preferences and personality compared to an assessment based on the questions answered by the user.

The AI model 112 may include a multi-layer perceptron. The multi-layer perceptron may be used as a decoder to decode the encoded personal information. In embodiments, the multi-layer perceptron may have multiple heads. In some embodiments, the multi-layer perceptron may have one head for each of the one or more questionnaires. In further embodiments, the multi-layer perceptron may use one-hot encoding to represent each questionnaire.

Training device 120 may include memory which stores a training dataset 122. The training device 120 may include a training user interface 124. The training user interface 124 may be configured to allow one or more users to answer questions of a questionnaire (described in more detail below). The training user interface 124 may be a touchscreen, a keyboard, a set of buttons, or any other suitable user interface for allowing a user to answer questions of a questionnaire.

The training dataset 122 may include one or more questionnaires. The one or more questionnaires may also be referred to as surveys, polls, personality indexes, or other suitable terms. Each of the one or more questionnaires may include one or more questions. Each of the one or more questions of the one or more questionnaires may have a plurality of answer preferences associated with the question. In some embodiments, the one or more questions of the one or more questionnaires may allow a user to write-in their own answer. In embodiments, the one or more questionnaires may be a plug-in hybrid electric vehicle (pHEV) questionnaire, a gambling questionnaire, an actively open-minded thinking beliefs (AoT) questionnaire, a demographic questionnaire, a pro-social questionnaire, or a Big Five questionnaire. The pHEV questionnaire may include questions about a user's willingness to purchase or own a pHEV compared to a user's willingness to purchase or own an internal combustion engine vehicle. The gambling questionnaire may include simulated gambling scenarios and the user's willingness to gamble based upon payouts, odds, recipients of winnings, and/or other factors. The AoT questionnaire may include questions about a user's willingness to consider alternative options or conclusions. The demographic questionnaire may include questions about various demographic information about the user, such as age, gender, race, income, political leaning, location, or other demographic information. The pro-social questionnaire may include questions about the willingness of the user to voluntarily help others. The Big Five questionnaire may include questions to determine the personality traits of extroversion, agreeableness, openness, conscientiousness, and neuroticism.

The training dataset 122 may classify all of an individual user's answers to all of the questions from all of the datasets of which they provided answers as an individual dataset. In some embodiments, the individual user may provide answers to every question of every questionnaire. In other embodiments, the individual user may provide answers to only a portion of questions or a portion of questionnaires. In embodiments, a plurality of users may provide answers. Each of the plurality of users' answers may be compiled into a unique individual dataset for each of the plurality of users.

The training dataset 122 may include one or more of the individual datasets compiled into a first batch of individual datasets. The training dataset 122 may include one or more of the individual datasets compiled into a second batch of individual datasets, where the one or more individual datasets which make up the second batch of individual datasets differs from the one or more individual datasets which make up the first batch of individual datasets. The training dataset 122 may include a further number of batches of individual datasets, each of the further number of batches of individual datasets being made up of different groupings of individual datasets than the other batches of individual datasets. In one embodiment, the first batch of individual datasets may include a plurality of individual datasets. The second batch of individual datasets may include a single individual dataset, which may be a target dataset. The target dataset may be answers to a questionnaire which may be administered to a user to predict the user's likely answers to other questionnaires, as will be described in more detail herein.

The training dataset 122 may be formatted as a matrix of the individual datasets, the matrix sized such that each batch of individual datasets may form the columns of the matrix and each questionnaire may form the rows of the matrix. In embodiments where each batch of individual datasets does not include answers to each question of each of the plurality of questionnaires, zero masking may be used whereby the missing data may be replaced with zeros such that the matrix maintains the same size regardless of partially completed questionnaires. This may simplify the training process of the AI model 112.

The training dataset 122 may be embedded into a joint embedding space. The joint embedding space may allow the AI model 112 to better learn the relationships between the one or more questions and the one or more questionnaires compared to a dataset not embedded into a joint embedding space.

AI device 110 may receive data from server 130, training device 120, and/or other servers (not shown) available via network 140. Although shown as separate entities in FIG. 1, server 130, AI device 110, and/or training device 120 may be combined. For example, server 130 may include one or more AI models 112 in addition to or instead of an AI device 110, and server 130 may include the training dataset 122 in addition to or instead of the training device 120. Furthermore, server 130, AI device 110, and training device 120 may exchange data directly or via network 140.

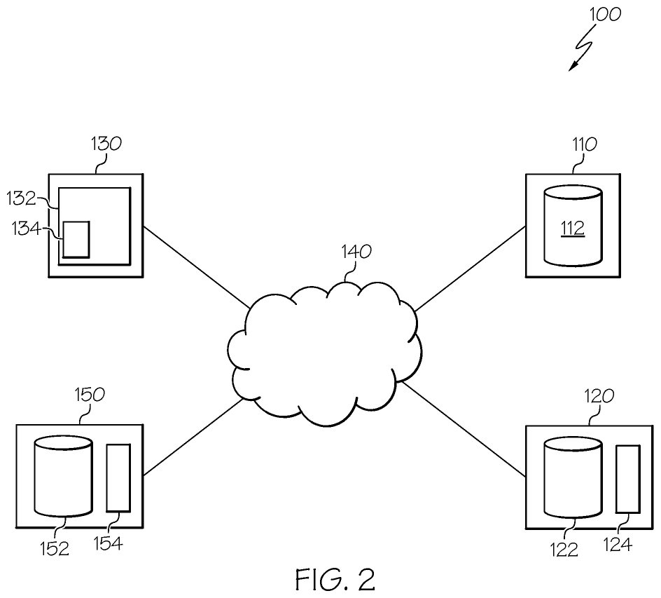

Referring now to FIG. 2, an example of the system 100 for training and testing the AI model 112 is shown consistent with a disclosed embodiment. As shown in FIG. 2, the AI device 110, the training device 120, the server 130, and a testing device 150 are communicatively coupled to one another via a network 140. Although a specific numbers of AI devices, training devices, servers, and testing devices are depicted in FIG. 2, any number of these devices may be provided. Furthermore, the functions provided by one or more devices of system 100 may be combined and the functionality of any one or more components of system 100 may be implemented by any appropriate computing environment.

Network 140 facilitates communications between the various devices in system 100, such as AI device 110, training device 120, server 130, and testing device 150. Testing device 150 may be any device capable of storing a testing dataset 152 and having a testing user interface 154 communicatively coupled thereto. The testing device 150 may allow one or more users to provide answers to one or more questions of the one or more questionnaires. The one or more users may provide answers via the testing user interface 154. The testing user interface 154 may be a touchscreen, a keyboard, a set of buttons, or any other suitable user interface for allowing a user to answer questions of a questionnaire. The answers provided by the user may be stored on the testing dataset 152.

The testing dataset may be divided into an input portion and a results portion. The input portion of the testing dataset may be input into the AI model 112. The AI model 112 may predict a user's likely answer to one or more questions of the results portion based upon the answers from the input portion. The predicted answers generated by the AI model 112 may be compared to the results portion in order to determine the performance of the AI model 112.

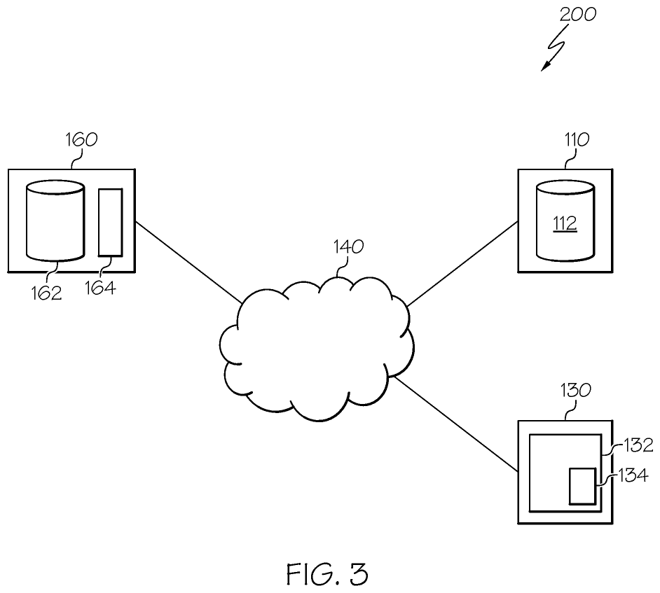

Referring now to FIG. 3, an example of a system 200 for deploying the AI model 112 is shown consistent with a disclosed embodiment. As shown in FIG. 3, the AI device 110, the training device 120, the server 130, and a question taking device 160 are communicatively coupled to one another via a network 140. Although a specific numbers of AI devices, training devices, servers, and question taking devices are depicted in FIG. 3, any number of these devices may be provided. Furthermore, the functions provided by one or more devices of system 200 may be combined and the functionality of any one or more components of system 200 may be implemented by any appropriate computing environment.

Network 140 facilitates communications between the various devices in system 200, such as AI device 110, training device 120, server 130, and question taking device 160. Question taking device 160 may allow one or more users to provide answers to one or more questions of the one or more questionnaires. The one or more users may provide answers via the question taking user interface 164. The question taking user interface 164 may be a touchscreen, a keyboard, a set of buttons, or any other suitable user interface for allowing a user to answer questions of a questionnaire. The answers provided by the user may be stored on the answer dataset 162. The AI model 112 may compress the answer dataset into a latent vector.

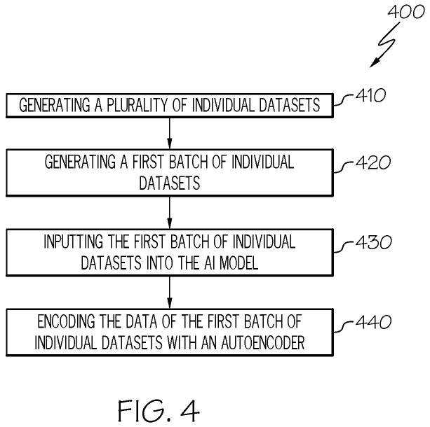

Referring now to FIG. 4, an illustration of a method 400 is illustrated consistent with a disclosed embodiment. The method 400 is directed at training the artificial intelligence model 112. At step 410, the method 400 includes generating a plurality of individual datasets. That is, a first user may answer one or more questions of one or more questionnaires. The first user may answer the questions via the training user interface 124. The answers may be saved to the training dataset 122. The answers may be compiled by the training device 120 to generate an individual dataset.

In embodiments, a plurality of users may answer one or more questions of one or more questionnaires. A plurality of individual datasets may be generated by the training device 120, such that one individual dataset is generated for each users' answers. In some embodiments, each user may answer every question of every questionnaire. In other embodiments, each user may answer a portion of questions within a single questionnaire, a portion of the questionnaires, or any other combinations of questions and questionnaire. Any suitable number of individual datasets may be generated by the training device 120, including but not limited to one individual dataset, two individual datasets, five individual datasets, ten individual datasets, one-hundred individual datasets, or any other suitable number of individual datasets.

At step 420, the method 400 includes generating a first batch of individual datasets. The first batch of individual datasets may include one or more of the individual datasets. The training device 120 may compile one or more of the individual datasets to generate the first batch of individual datasets. In embodiments, the training device 120 may generate a plurality of batches of individual datasets. Each of the plurality of batches of individual datasets may be different combinations of the individual datasets.

At step 430, the method 400 includes inputting the first batch of individual datasets into the AI model 112. That is, the first batch of individual datasets may be transferred from the training device 120 to the AI device 110 so that the first batch of individual datasets may be inputted into the AI model 112. The first batch of individual datasets may be transferred via the network 140.

At step 440, the method 400 includes encoding the data of the first batch of individual datasets with an autoencoder. That is, the AI model 112 may include the autoencoder. The autoencoder may encode the data of the first batch of individual datasets such that the AI model 112 may more quickly learn relationships between questions, such as between questions in one of the questionnaires or between questions in different questionnaires.

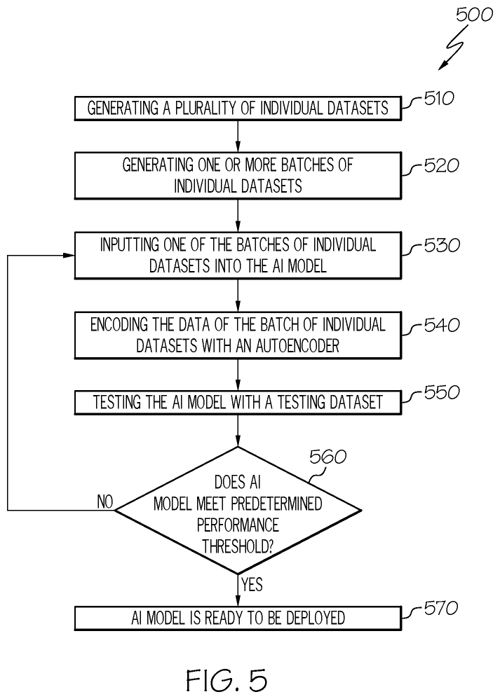

Referring now to FIG. 5, an illustration of a method 500 is illustrated consistent with a disclosed embodiment. The method 500 is directed at training and testing the artificial intelligence model 112. At step 510, the method 500 includes generating a plurality of individual datasets. That is, a first user may answer one or more questions of one or more questionnaires. The first user may answer the questions via the training user interface 124. The answers may be saved to the training dataset 122. The answers may be compiled by the training device 120 to generate an individual dataset.

In embodiments, a plurality of users may answer one or more questions of one or more questionnaires. A plurality of individual datasets may be generated by the training device 120, such that one individual dataset is generated for each users' answers. In some embodiments, each user may answer every question of every questionnaire. In other embodiments, each user may answer a portion of questions within a single questionnaire, a portion of the questionnaires, or any other combinations of questions and questionnaire. Any suitable number of individual datasets may be generated by the training device 120, including but not limited to one individual dataset, two individual datasets, five individual datasets, ten individual datasets, one-hundred individual datasets, or any other suitable number of individual datasets.

At step 520, the method 500 includes generating one or more batches of individual datasets. Each of the one or more batches of individual datasets may include one or more of the individual datasets. The training device 120 may compile one or more of the individual datasets to generate the one or more batches of individual datasets. Each of the plurality of batches of individual datasets may be different combinations of the individual datasets.

At step 530, the method 500 includes inputting one of the one or more batches of datasets into the AI model 112. That is, the one or more batches of individual datasets may be transferred from the training device 120 to the AI device 110 so that the one or more batches of individual datasets may be inputted into the AI model 112. The one or more batches of individual datasets may be transferred via the network 140. In embodiments, one batch of individual datasets may be transferred at a time. In other embodiments, multiple batches of individual datasets may be transferred at a time.

At step 540, the method 500 includes encoding the data of the first batch of individual datasets with an autoencoder. That is, the AI model 112 may include the autoencoder. The autoencoder may encode the data of the one or more batches of individual datasets such that the AI model 112 may more quickly learn relationships between questions, such as between questions in one of the questionnaires or between questions in different questionnaires.

At step 550, the method 500 includes testing the AI model 112 with the testing dataset. That is, a testing dataset may be prepared, such as by a plurality of users answering questions from a plurality of questionnaires stored on the testing device. The input portion of the testing dataset may be input into the AI model 112. The AI model 112 may predict the user's answers to the questions from the results portion. The answers predicted by the AI model 112 may be compared to the results portion of the testing dataset to determine the performance of the AI model 112.

At step 560, the method 500 includes determining if the AI model 112 meets a predetermined performance threshold. That is, the system 100 may compare the results from step 540 to determine if the AI model 112 meets or exceeds a performance threshold. In some embodiments, a user may specify the performance threshold. In other embodiments, the system 100 may have a predetermined performance threshold. If it is determined the AI model 112 does meet the predetermined performance threshold (Yes at step 560), the method 500 proceeds to step 570. If it is determined the AI model 112 does not meet the predetermined performance threshold (No at step 560), the method 500 returns to step 530.

At step 570, the method 500 includes the AI model 112 being ready to be deployed. That is, the AI model 112 may be used to predict a task output.

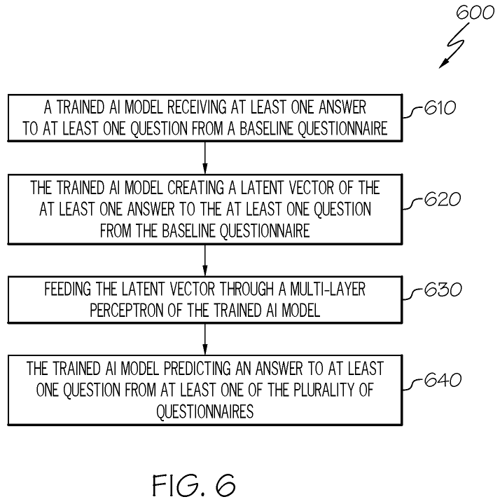

Referring now to FIG. 6, an illustration of a method 600 is illustrated consistent with a disclosed embodiment that may be performed by the system 100. The method 600 is directed at using the AI model 112 to predict a task output.

At step 610, the method 600 includes the trained AI model 112 receiving at least one answer to at least one question from a baseline questionnaire. A user may answer one or more questions from one or more questionnaires via the question taking user interface 164. Any of the one or more questionnaires may be used as the baseline questionnaire. The one or more answers of the baseline questionnaire may be stored in the answer dataset 162. In embodiments, the baseline questionnaire may be a pHEV questionnaire, a gambling questionnaire, an AoT questionnaire, a demographic questionnaire, a pro-social questionnaire, or a big five questionnaire.

At step 620, the method 600 includes the trained AI model 112 creating a latent vector of the at least one answer to the at least one question from the baseline questionnaire. That is, the AI model 112 may compress the data comprising the answer dataset 162 into the latent vector.

At step 630, the method 600 includes feeding the latent vector through a multi-layer perceptron of the trained AI model 112. That is, the multi-layer perceptron of the AI model 112 may decode the latent vector in order to interpret the answer dataset 162 which makes up the latent vector. By decoding the latent vector, the AI model 112 may analyze the answer dataset 162.

At step 640, the method 600 includes the trained AI model 112 predicting an answer to at least one question from at least one of a plurality of questionnaires. That is, the AI model 112 may predict an answer to one of the plurality of questionnaires that was not used as the baseline questionnaire. This may allow the system 100 to make determinations about a user's preferences without the user needing to answer every question of every questionnaire. In embodiments, the plurality of questionnaires may be a pHEV questionnaire, a gambling questionnaire, an AoT questionnaire, a demographic questionnaire, a pro-social questionnaire, or a big five questionnaire.

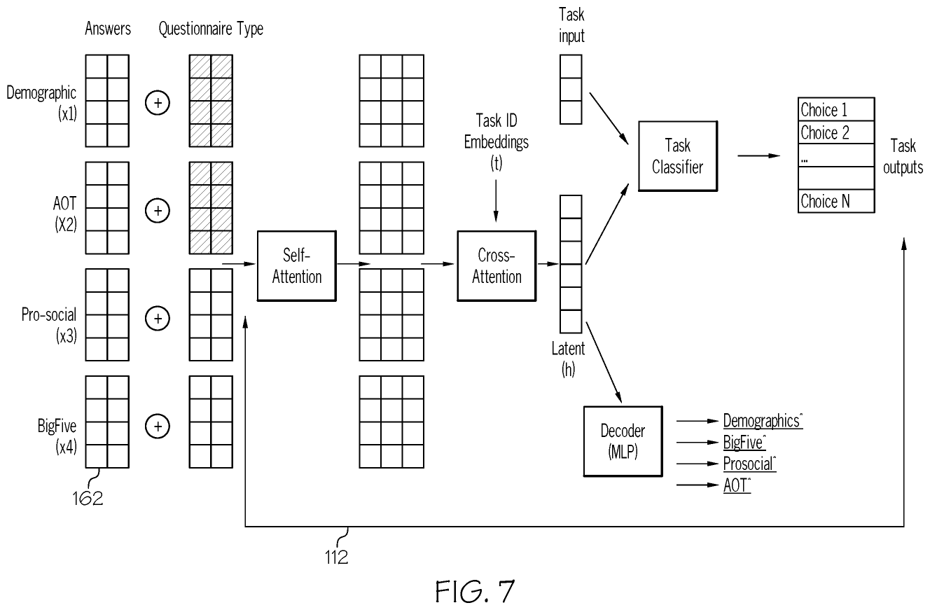

Referring now to FIG. 7, an example of a flowchart of deploying the AI model 112 is shown consistent with a disclosed embodiment. The answer dataset 162 is shown as a plurality of matrices, where each matrix corresponds to answers from one of the plurality of questionnaires. The AI model 112 is shown as a flowchart of elements which may be included in the AI model 112. The AI model 112 may also be called a Personalized Attention Network (PAN) model.

The AI model 112 may include two transformer networks. One of the transformer networks may be a self-attention network that enables the model to learn the importance of individual questionnaire answers in the context of a set of questionnaires. Another of the transformer networks may be a cross-attention network that takes the output of self-attention layers and task identification embeddings to summarize a user's specific characteristics from different questionnaire answers. The transformer architecture may use attention mechanisms to help with understanding what input features are useful for the specific task in the human decision making process. The output of the cross-attention module may be converted into a latent vector, which will be fed into both the classification network for predicting the task outputs and a MLP decoder for reconstructing the input questionnaires.

The input for the AI model 112 may be the answer dataset 162. The answer dataset 162 may be embedded and denoted as x₁, x₂, x₃, . . . , xₙ which may be input into the self-attention network. Each questionnaire answer may be first represented using a one-hot encoding. In this case, the dictionary of words is the maximum value that can occur in the input questionnaire (range between 10 to 60). Using the one-hot representation of the answer dataset 162, an embedding layer may be used to encode the answers into a 32-dimensional embedding such that each input answer is represented by a 32d vector. This will result in a Demongraphic embedding x₁ with a size of 7×32 dimensions, an AOT embedding x₂ with a size of 10×32 dimensions, a Pro-social embedding x₃ with a size of 4×32 dimensions and a BigFive embedding x₄ with a size of 10×32 dimensions.

Answers from different questionnaire types may be differentiated using unique questionnaire type embeddings. This is similar to the positional embeddings from text processing approaches but only differs that the answers from the same questionnaire type will have the same type embedding. Similar to the embeddings for questionnaire answers, the integer-vector representation of the questionnaire type is converted to a 32-dimensional embedding. The type embeddings are added to the answer embeddings x which result in \tilde{ }x that remains the same size. If one questionnaire is missing, zero masking may be used so that the same input size can be preserved during training. The \tilde{ }x from all questionnaires may be concatenated to provide as input to the transformer encoder. This may result in a 31×₃₂-dimensional embedding \tilde{ }X=[\tilde{ }x₁, \tilde{ }x₂, \tilde{ }x₃, \tilde{ }x₄] to go through the self-attention mechanism.

Two transformer blocks may be stacked to capture the interaction between questionnaires.

This is due to the observation that self-attention has been demonstrated to be powerful in inferring context and weight importance of individual input with regard to other inputs. The questionnaire embeddings \tilde{ }X may be input into the transformer encoder to get hidden representations: Zₛₐ=MultiHeadAttn(f_{Q}(\tilde{ }X), f_{K}(\tilde{ }X), f_{V}(\tilde{ }X)), where f(\tilde{ }X) denotes the transformation for query, key and value that are projected from inputs utilizing three weight matrices denoted as Wq, Wk, and Wv. MultiHeadAttn represents the stacked multi-head attention block, where the set the number of heads may be set to four in the multiheadattention models. The output hidden representation Zₛₐ from the self-attention layers may be an attention-weighted version of the query input \tilde{ }X and is set to have the same number of 32 features, thus resulting in a same size of 31×32 as \tilde{ }X.

In order to learn representations that are relevant for different tasks, a cross-attention block to inject task type knowledge may be used. This is achieved through a transformer decoder that takes two inputs: the self-attention representation Zₛₐ for questionnaires and a task ID embedding t. The discrete task ID may be converted into a 32 dimensional embedding vector t because the embedding dimensions of two inputs to the cross-attention block must match. The task-specific module is defined as follows: Z_{ca}=MultiHeadAttn(f_{Q}(t), f_{K}(Zₛₐ), f_{V}(Zₛₐ)), where Z_{ca} is the final output of the attention mechanism which represents task-specific questionnaire answer information.

The learned joint questionnaire representation Z_{ca} is first converted to a latent vector h. After that, h is used for two prediction tasks: task outputs Y and original questionnaire answers Q. An MLP network may be used to predict task outputs that takes a concatenation of the latent vector h and task input features. The objective of task outputs prediction \hat{ }Y can be denoted as: 1_{pred}=(Yᵢ−\hat{ }Yᵢ)², where a MSE may be used in the loss function. MSE may be used instead of cross-entropy is that human decision making behavior is inherent noisy and inconsistent. Prior work found that using cross-entropy tends to make models prone to over fitting to noisy labels.

The decoder may be a shallow multi-layer perceptron with multiple heads (one head for each questionnaire). This mechanism is used to so that the model can use fewer questionnaires. The loss objective for reconstructing the input questionnaire answers \hat{ }Q is: 1_{dec}=2 Eⁿᵢ₌₁(qᵢ−\tilde{ }qᵢ)².

To encourage the model to learn to predict using smaller number of questionnaires, a questionnaire input rotation scheme may be used during training. Specifically, the number of input questionnaires varies between batches so the model may receive either all questionnaires as input or one questionnaire as input. Regardless of the number of input questionnaires (hence the amount of information contained in the latent vector), the decoder uses the latent vector to predict back the input. This decoding is possible even with just a single questionnaire input because the smaller set of questionnaires is a subset of the full set of questionnaires.

During testing, the proposed model can perform prediction using fewer questionnaires than the number of questionnaires used during training. The decoder outputs are also not used during testing.

Since the proposed model uses self-attention and cross-attention to select the relevant questionnaires for the task, the attention weights can be used to visualize what the models pay attention to that helps its predictions. Furthermore, the self-attention weights may be inspected to understand the relationships between the questions in different questionnaires. The self-attention and cross-attention weights for all subjects in the test set may be collected. The attention weights are then averaged across subjects and visualized.

Accordingly embodiments of the present disclosure provide methods for training and deploying an artificial intelligence model to predict a task output. The method for training the artificial intelligence model may include generating a plurality of individual datasets based on a user's answers to questions from questionnaires. The method may include generating a first batch of individual datasets, where the first batch of individual datasets is made up of the plurality of individual datasets. The first batch of individual datasets may be input into the artificial intelligence model to train the artificial intelligence model. The method for deploying an artificial intelligence model to predict a task output may include the trained artificial intelligence model receiving an answer to a question. The trained artificial intelligence model may predict a user's likely answers to further questions based upon the user's answer to the first question.

It may be noted that one or more of the following claims utilize the terms “where,” “wherein,” or “in which” as transitional phrases. For the purposes of defining the present technology, it may be noted that these terms are introduced in the claims as an open-ended transitional phrase that are used to introduce a recitation of a series of characteristics of the structure and should be interpreted in like manner as the more commonly used open-ended preamble term “comprising.”

It should be understood that any two quantitative values assigned to a property may constitute a range of that property, and all combinations of ranges formed from all stated quantitative values of a given property are contemplated in this disclosure.

Having described the subject matter of the present disclosure in detail and by reference to specific embodiments, it may be noted that the various details described in this disclosure should not be taken to imply that these details relate to elements that are essential components of the various embodiments described in this disclosure, even in casings where a particular element may be illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

What is claimed is:

1. A method for training an artificial intelligence model, the method comprising:
generating a plurality of individual datasets, each of the plurality of individual datasets comprising data of at least one answer to at least one of a plurality of questions of each of a plurality of questionnaires;
generating a first batch of individual datasets, the first batch of individual datasets comprising one or more of the plurality of individual datasets;
inputting the first batch of individual datasets into the artificial intelligence model; and
encoding the data of the first batch of individual datasets with an autoencoder.

2. The method of claim 1, further comprising:
generating the plurality of questionnaires, each of the plurality of questionnaires comprising one or more questions.

3. The method of claim 1, further comprising:
generating a second batch of individual datasets, the second batch of individual datasets comprising a different combination of one or more of the plurality of individual datasets than the first batch of individual datasets.

4. The method of claim 1, wherein the first batch of individual datasets comprises a matrix of one or more answers to the plurality of questionnaires.

5. The method of claim 4, wherein the matrix is sized to such that one answer to each of the plurality of questions of the plurality of questionnaires is included in the matrix.

6. The method of claim 5, wherein the matrix uses zero masking when the first batch of individual datasets comprises less than one answer to each of the plurality of questions of the plurality of questionnaires.

7. The method of claim 1, wherein a plurality of users provides answers to the plurality of questions of each of the plurality of questionnaires.

8. The method of claim 1, wherein the plurality of questionnaires comprises at least one of a pHEV questionnaire, a gambling questionnaire, an AoT questionnaire, a demographic questionnaire, a pro-social questionnaire, or a big five questionnaire.

9. The method of claim 1, wherein the artificial intelligence model is measured with a loss function.

10. The method of claim 9, wherein the loss function comprises the sum of a choice prediction loss and a reconstruction loss, and wherein the choice prediction loss and the reconstruction loss are the mean squared error between a true target and a predicted output of the artificial intelligence model.

11. The method of claim 1, wherein the plurality of questionnaires are embedded within a joint embedding space.

12. The method of claim 1, wherein the artificial intelligence model comprises a plurality of transformer blocks.

13. The method of claim 1, further comprising:
testing the artificial intelligence model with a testing dataset, the testing dataset comprising fewer answers to the plurality of questions of each of the plurality of questionnaires than the first batch of individual datasets.

14. The method of claim 13, wherein the testing dataset comprises one or more answers to one of the plurality of individual datasets, and the first batch of individual datasets comprises one or more answers to a plurality of the plurality of individual datasets.

15. The method of claim 13, further comprising:
determining if the artificial intelligence model exceeds a predetermined performance threshold; and
if the artificial intelligence model does not exceed the predetermined performance threshold:
generating a second batch of individual datasets;
inputting the second batch of individual datasets into the artificial intelligence model; and
encoding the data of the second batch of individual datasets with the autoencoder.

16. A method for predicting a task output with a trained artificial intelligence model, the method comprising:
the trained artificial intelligence model receiving at least one answer to at least one question from a baseline questionnaire;
the trained artificial intelligence model comprising a self-attention layer, the self-attention layer creating a latent vector of the at least one answer to the at least one question from the baseline questionnaire;
feeding the latent vector through a decoder of the trained artificial intelligence model; and
the trained artificial intelligence model predicting an answer to at least one question from at least one of a plurality of questionnaires, each of the plurality of questionnaires being different than the baseline questionnaire.

17. The method of claim 16, further comprising:
the baseline questionnaire comprising a plurality of questions; and
the trained artificial intelligence model receiving a plurality of answers to the plurality of questions of the baseline questionnaire.

18. The method of claim 16, wherein the baseline questionnaire comprises at least one of: a pHEV questionnaire, a gambling questionnaire, an AoT questionnaire, a demographic questionnaire, a pro-social questionnaire, or a big five questionnaire.

19. The method of claim 16, wherein the plurality of questionnaires comprises at least one of: a pHEV questionnaire, a gambling questionnaire, an AoT questionnaire, a demographic questionnaire, a pro-social questionnaire, or a big five questionnaire.

20. The method of claim 16, further comprising feeding the latent vector through a multi-layer perceptron of the trained artificial intelligence model.
